(19) United States
(12) Patent Application Publication
(10) Pub. No.: US 2005/0258272 A1
(43) Pub. Date: Nov. 24, 2005

(54) Spray dispenser assembly and vessel therefor

(75) Inventor: John Richard Salvage, Surrey (GB)

Correspondence Address: MERCHANT & GOULD PC, P.O. BOX 2903, MINNEAPOLIS, MN, 55402-0903, US

(73) Assignee: SHIELD MEDICARE LIMITED, Farnham (GB)

(21) Appl. No.: 10/524,255

(22) PCT Filed: Aug. 12, 2003
(86) PCT No.: PCT/GB03/03505

§ 371 Date: Feb. 10, 2005

Related U.S. Application Data
(60) Provisional application No. 60/403,476, filed on Aug. 13, 2002.

(30) Foreign Application Priority Data
Aug. 13, 2002 (GB) 0218801.9

(51) Int. Cl. B05B 11/04

(52) U.S. Cl. 239/328

(57) ABSTRACT

A spray dispenser assembly (1) for the dispensing of liquids suitable for use in clean-room environments comprising (a) a collapsible liquid impermeable vessel (4) having an open end comprising a neck portion (5) provided with a collar (8) that is more rigid than the vessel (4); the collar (8) being adapted to sealingly engage with seal means (12) provided between the extraction means of the spray dispenser assembly (1) and the vessel (4); (b) extraction means for extracting liquid from the vessel (4) and dispensing the liquid as a spray; and (c) seal means (12) arranged in sealing position to substantially seal the vessel to the extraction means and substantially inhibit the ingress of air into the vessel (4); the seal means (12) and extraction means being arranged such that the extraction means is operable to dispense liquid from the vessel (4) whilst the seal means (12) is in a sealing position. Collapsible vessels for use in such spray assemblies and kits comprising the collapsible vessels are also disclosed.

The present invention relates to spray dispenser assemblies and vessels therefor and in particular to those suitable for use in spray dispensing sterile or reactive liquids.

Aerosol or spray dispensers are commonly used for dispensing sprayed sterile or reactive fluids in “clean room” environments such as hospitals, pharmaceutical preparation areas and food preparation areas, and associated support areas (including for example a clean room that provides access to a further clean room having more stringent cleanliness and/or sterility requirements).

Many liquid spray dispensers use an aerosol cartridge to provide compressed gas for atomising the liquid product and driving it out through the nozzle. However, it is now apparent that certain of the gases most often used in spray cartridges, such as fluorocarbons, are highly toxic and harmful to the environment.

Spray dispensers fitted with manual trigger sprays are well known. In such a dispenser a liquid spray bottle is fitted with a spray pump which has a spray nozzle at the mouth of a liquid container. When the spray pump is operated, the liquid is drawn up to the spray nozzle through a suction pipe which is inserted within the liquid container and sprayed out through to spray nozzle. For this arrangement to work the spray bottle must be open to the outside atmosphere for the purpose of drawing outside air into the container when the spray pump is operated to spray out the liquid. This mechanism of action is unacceptable for sterile liquids and in a clean room environment as the liquid in the container may be contaminated by particles, including bacteria, present in the air.

Our previous patent application published as GB 2 333 129 A (herein incorporated in full by reference) describes a spray dispenser with collapsible bag, which attempted to overcome problems in the prior art. These type of dispensers will hereinafter be termed “bag in bottle dispensers”. The bag described is in sealing engagement with the trigger pump, and air is prevented from flowing into the bag. The bag collapses as liquid is dispensed. To allow the pump to function correctly a vent is provided from the extraction means, but this is external of the bag to prevent contamination of liquid contained therein.

Continued testing of the dispenser described in GB 2 333 129 A shows that the assembly has a problem with leakage. Studies of the prior art device show that leakage is caused by a poor seal provided between the bag, the bung, the support means and the cap of the support means. Improvements to the bag used overcome this problem.

Accordingly the present invention provides in a first aspect a collapsible liquid impermeable vessel for use in a spray dispenser assembly,
the vessel having an open end comprising a neck portion provided with a collar that is more rigid than the vessel;
the collar being adapted to sealingly engage with seal means provided between the extraction means of the spray dispenser assembly and the vessel.

By providing an at least semi-rigid collar on the vessel, the sealing means may engage directly with the vessel, providing a more complete seal than in the prior art, which relied on a seal between the bung, bag, support neck and cap. This improvement has been shown to provide a substantially stronger seal and lower the amount of leakage to a negligible level.

The collar may be formed separately from the neck portion and joined thereto around the collar circumference. Preferably the collar is inserted into the neck portion of the vessel and welded around the collar circumference, preferably completely around the collar circumference. A complete circumferential weld may be achieved by performing the welding process more than once, the orientation of the collar and neck in the welding apparatus being altered between each welding process so that a complete and secure circumferential weld is formed. This may be achieved by rotating the neck and collar about the longitudinal axis of the vessel by a suitable angle, for example about 90° C., between successive welds being applied.

By providing the collar inside the neck of the vessel, with the seal provided between the inside face of the collar and the seal means, any leakage between the join of the collar to the neck is provided external to the vessel and away from the extraction means. As the vessel is intended for use within a support means, any leakage from the neck to collar join will fall within the support means.

In the prior art device, as the bag was folded over the neck of the support vessel, any leakage from the bag and the seal means could flow onto the exterior of the support means and possibly into contact with the hands of a user. This could be particularly dangerous if the liquid contained within the dispenser was of a hazardous nature.

The vessel may be made from two sheets of plastics material welded together at their edges to form a substantially cylindrical vessel providing a neck end with an open neck portion disposed at one end thereof, with a collar disposed therein, and a closed end opposite the neck end. It will be understood that the cylindrical vessel will have a cross-sectional shape that is substantially the same along the majority of its length. That cross-sectional shape may be in the form of a very thin rectangular shape when the vessel is empty. When the vessel contains liquid it may lose at least some of its cylindrical shape as the cross-sectional shape of the vessel may vary along its length.

According to a preferred embodiment of the present invention leakage has been shown to be reduced further by trimming the neck portion of the welded vessel before welding the collar in the neck of the vessel. This prevents any excess material on the neck from pinching around the collar, thus potentially forming conduits for liquid to leak through.

The weld between the neck and the collar is preferably 5 mm wide.

In a preferred embodiment the closed end of the vessel, opposite the neck end, is substantially curved. This provides for less stress points on the vessel than if the closed end were flat.

The neck portion may be disposed in the centre of the neck end of the vessel or may be offset to one side of the neck end of the vessel, in which case it is preferred to provide additional strengthening around the neck end of the vessel.

The collar is preferably annular and is adapted to sealingly engage with annular sealing means.

Advantageously the collar is substantially tapered so that pushing seal means into the collar provides a progressively greater seal.

According to a preferred embodiment the collar has an annular lip adapted to rest upon the neck of a support means. Such collar locates the vessel on the support means and is capable of holding the vessel in position with regard to the support means when the support means is provided with a cap or lid.

The vessel preferably comprises flexible sheet or membrane material and generally provides a flaccid bag or pouch which may be incapable of self support. Preferably the vessel comprises a di- or tri-lumen bag.

Depending on the envisaged contents of the vessel the material from which it is made may be very important. It is preferred that the vessel comprises plastics material which is inert, even upon gamma irradiation or contact with biocides or other liquids that it may be used to contain. The material used is preferably elastic so that the vessel may be inflated to many times its original size and is preferably resistant to degradation at high temperature.

The collar of the vessel may also comprise plastics material although this is thicker than that used for the vessel itself.

The collar and the neck portion (and preferably the rest of the vessel) are preferably made from the same material, which is generally formed from granulated or particulate material which is blow moulded to form the collar and bag. Producing the neck portion (or bag) and collar from the same material has the advantage of ensuring the integrity of the weld as it is easier to weld components of the same material.

The vessel according to the present invention may be provided with seal means in sealing engagement with the collar thereof.

The term “seal means” is intended to encapsulate anything that may provide a seal with the collar. Such a seal includes those that may be formed by virtue of frictional engagement or by virtue of materials added to form or improve a seal such as adhesives.

The seal means preferably comprises a seal element (such as a stopper, plug or bung) arranged to sealingly engage with the liquid impermeable container proximate the open end thereof so as to seal the collapsible liquid impermeable container. The seal means preferably comprises resiliently flexible material such as rubber or the like.

The seal means may comprise material which is capable of being irradiated and is inert even when in contact with biocides.

The seal means preferably comprises an annular lip which is adapted to sit on an annular lip provided on the collar, providing additional sealing points.

The vessel and seal means arrangement may be in sealing engagement with extraction means for extracting liquid from a vessel and dispensing the liquid as a spray.

As described above most of the improvements in the dispensing device described in GB 2 333 129 relate to the liquid containing vessel.

The present invention, however, also provides in a second aspect a spray dispenser assembly comprising
(a) a collapsible liquid impermeable vessel as described in accordance with the first aspect of the invention;
(b) extraction means for extracting liquid from the vessel and dispensing the liquid as a spray; and
(c) seal means arranged in sealing position to substantially seal the vessel to the extraction means and substantially inhibit the ingress of air into the vessel;
the seal means and extraction means being arranged such that the extraction means is operable to dispense liquid from the vessel whilst the seal means is in a sealing position.

The seal means is preferably arranged to receive a dispensing line extending into the interior of the vessel. The dispensing line (which may, typically be an elongate tube) preferably extends through the seal means being gripped in sealing engagement with a bore or aperture provided through the seal means. Alternatively, the dispensing line may be bonded in the bore or aperture by a sealing adhesive.

The extraction means preferably comprises pressure means for creating a differential pressure to dispense liquid from the vessel.

The extraction means may comprise pump means (typically actuatable by a trigger pumping mechanism) to dispense liquid from the vessel. The arrangement of the seal means and differential pressure extraction means ensures that any exhaust air or back pressure does not result in ambient air being drawn into the vessel. This may be achieved by ensuring that any vent or back pressure release of the extraction means/pump trigger arrangement is positioned externally of the seal means. Because the vessel collapses as liquid is dispensed, little or no back pressure (vacuum) exists in the vessel.

The extraction means preferably further includes a nozzle for ensuring liquid is dispensed as a spray.

The term “extraction means” is intended to include any dispensing mechanism, typically having an inlet disposed in the vessel in fluid communication with an outlet, and typically together with an actuator operable to control the release of the fluid from the vessel. The extraction means may comprise a pump, which may be hand-operated or mechanically assisted (e.g. electrical pump). Such hand-operated pumps may include push-button and/or trigger actuators. The extraction means may include a valve such as a needle valve, slit valve or poppet valve.

It is preferred that the dispenser further comprises support means for supporting the vessel container.

The support means preferably comprises an outer housing or container for the vessel, which outer housing or container is preferably substantially more rigid than the vessel.

The support means preferably includes an opening or support neck for locating the collar of the vessel. If the vessel has an annular lip this is intended to sit on the support neck of the support means to locate the vessel in the correct position with regard to the support means.

The support means may include an opening or support neck for locating the extraction means. The opening/neck is preferably arranged to cooperate in sealing engagement with the vessel.

The support means may comprise a vent permitting the air inside the support means (but externally) of the vessel to exist at ambient atmospheric pressure.

In one embodiment, the support means may comprise a bottle or the like (such as a plastics bottle), preferably having a neck opening for locating the vessel, and/or the extraction means.

In an alternative embodiment, the support means may comprise a frame structure, preferably having a support neck for locating the vessel, and/or the extraction means.

In a third embodiment the present invention provides a kit comprising a vessel according to the first aspect of the invention and a bung or stopper for sealing engagement therewith. The kit preferably further comprises extraction means for extracting liquid from the vessel and dispensing the liquid as a spray, sealing means to sealingly engage the vessel and extraction means, and support means for the vessel.

The kit preferably comprises a vessel according to the first aspect of the invention, a conventional pump dispenser trigger assembly, a bung adapted for sealing engagement with the vessel and having a bore therein adapted to sealingly engage with a dip tube of the trigger assembly, and a support container.

It will be appreciated that the vessel may be provided separate of the support means, trigger assembly and sealing means, each of which may be adapted from the art. The invention is intended to encompass the vessel with or without liquid contained therein.

The invention also provides a method of manufacturing a vessel according to any of the aspects of the invention described herein. The method may for example include a step of welding two sheets of plastic material together. The method may for example include a step of welding together two sheets of plastic material at their edges to form a substantially cylindrical vessel providing a neck end with an open neck portion disposed at one end thereof, with a collar disposed therein, and a closed end opposite the neck end. The method may include a step of welding a collar to a neck portion of the vessel. The method may include a step in which excess material is removed from around the neck portion prior to welding the collar thereto. The method may include a step of welding the collar to the neck portion with a welding apparatus, the collar being inserted into the neck portion and the welding apparatus then welding around the full collar circumference. Preferably the collar is joined to the neck portion by performing a plurality of welds, the orientation of the collar and neck in the welding apparatus being changed between each welding process so that a complete and secure circumferential weld is formed.

The invention will now be further described in a specific embodiment, by way of example only, and with reference to the accompanying drawings in which:

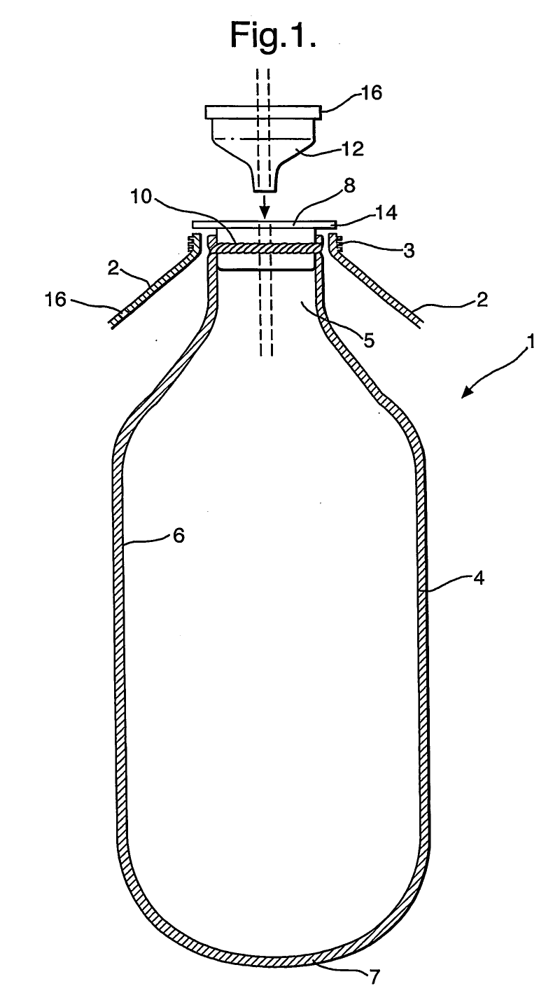

FIG. 1 is a schematic sectional view of an exemplary spray dispenser according to the invention;

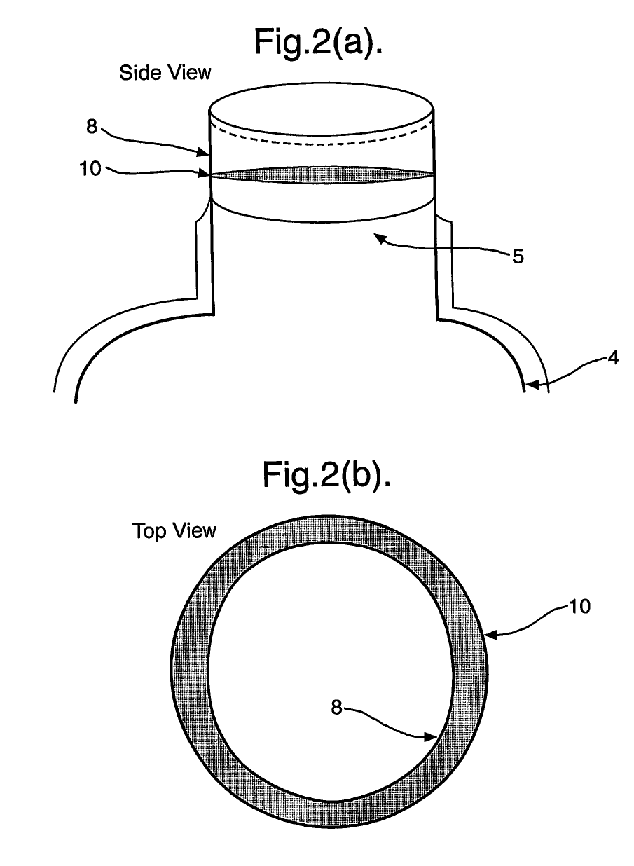

FIGS. 2a, b show details of the vessel according to a preferred embodiment of the invention; and

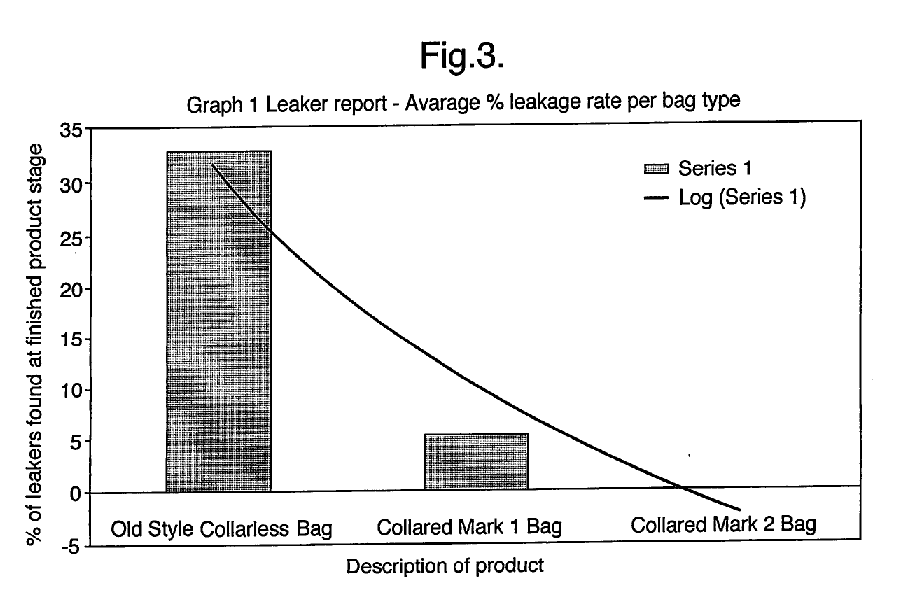

FIG. 3 is a graph showing a comparison between the leakage shown with the system of GB 2 333 129 A and vessels according to the present invention.

Referring to FIG. 1, there is shown a spray dispenser 1 comprising an outer plastics bottle 2 (shown in part only) having a neck 3 to which can be fitted a screw threaded plastics cap (not shown). A collapsible liquid impermeable vessel or bag 4 is disposed in the interior of the bottle 2.

The bag 4 comprises flexible plastics material which is inert upon irradiation and contact with biocides. The bag was made by heat welding two or more sheets of such plastics material to make an elongate cylinder with an open neck end 5 and a curved bottom 7. The seam 6 between the layers of material defines the interior of the bag 4.

An annular collar 8 is provided in the neck 5. Material around the seam 6 at neck 5 is cut away so that the collar 8 may be welded in the neck 5 without pinching of excess material. The weld 10 is provided completely around the circumference of the collar 8 and is at least 5 mm in width. Further detail of the collar and neck weld are apparent from FIG. 2.

The neck 5 was welded to the collar 8 by insertion of a conical former into the collar 8 and the application of two heated substantially hemi-annular welding heads (not shown) around the neck and collar as will now be explained in further detail. The two welding heads are brought together around the neck 5 and collar 8 and thus form a substantially annular weld around the whole circumference of the collar 8. The welding heads are then released and the neck 5 and collar 8 are rotated about the longitudinal axis of the vessel by a suitable angle, typically 90 degrees, before performing a further welding process on the collar 8 and neck 5 with the two welding heads. Any unwelded or poorly welded portions remaining from the first welding process are welded by the second welding process. For example, after only one welding process the weld could be unsatisfactory at the portion of the vessel corresponding to the area where the two welding heads meet during the welding process. As a result of the welding process, the weld 10 so formed defines a recessed annular groove.

An annular rubber sealing bung 12 is a tight press fit in the collar 8. Preferably the collar 8 has an annular lip 14 on its upper side, as does the bung 12 (indicated by numeral 16). When the bung 12 is in sealing engagement with the collar 8 the lips 14 and 16 meet to provide an additional sealing surface.

Bung 12 is provided with an axial aperture permitting a dip tube (indicated in dashed lines), connecting to a trigger assembly (not shown) to pass into the interior of the collapsible bag 4. The resilient nature of the bung 12 ensures that an airtight seal is provided between the axial aperture of bung 12 and the dip tube.

Alternatively, or additionally, the dip tube may be thermally bonded to the axial aperture of bung 12, and/or a sealant material applied.

The trigger assembly used in the dispenser device conforms in general to known prior art differential pressure pump arrangements in which actuation of the trigger causes a pressure differential drawing liquid along the dip tube and dispensing as a fine spray. The arrangement of the bung 12 and differential pressure extraction pump trigger arrangement ensures that any exhaust air or back pressure does not result in ambient air being drawn into the collapsible container. This is achieved by ensuring that any vent or back pressure release of the pump trigger arrangement is positioned externally of the seal means. Because the collapsible bag 4 collapses as liquid is dispensed, little or no back pressure (vacuum) exists in the flexible collapsing bag 4.

The plastics bottle 2 is provided with a vent 16 to atmosphere which prevents a partial vacuum being created between the interior walls of bottle 2 and the bag 4 as the bag collapses. Alternatively, the differential pressure created by the pump trigger arrangement may be sufficient to overcome any partial vacuum created in the interior of the bottle 2, externally of the collapsing bag 4.

Because of the extraction and seal arrangement, the spray dispenser of the present invention enables a manually actuatable differential pressure extraction arrangement (such as a trigger pump dispenser) to be used for applications requiring avoidance of atmospheric contamination of the sprayed dispenser contents.

### EXAMPLE

The vessel according to the present invention provides an improved spray dispenser assembly over that described in GB 2 333 129 A. To prove that the vessel of the present invention has less leakage than its predessor, the following experiment was carried out.

The following dispenser assemblies were simultaneously tested by filling the vessels with liquid, turning each support bottle upside down and leaving for 12 hours at room temperature and pressure. Leakage from the bags was measured by determining if any fluid was lost from the bag and also studying the bag and bottles for the presence of liquid.
Dispenser 1—as described in GB 2 333 129 A
Dispenser 2—collar arrangement as described in accordance with the present invention, with a single weld between the neck and collar and without the removal of material from around the seam at the neck prior to welding
Dispenser 3—collar arrangement as described in accordance with the present invention, with a 5 mm weld between the neck and collar around the full collar circumference and with the removal of material from around the seam at the neck prior to welding to prevent pinching.

The results are shown in FIG. 3 which shows a considerable reduction in leakage in dispenser 2, to an almost negligible level. No leakage was observed from dispenser 3.

1-23. (canceled)

24. A spray dispenser assembly for the dispensing of liquids suitable for use in clean-room environments comprising
(a) a collapsible liquid impermeable vessel having an open end comprising a neck portion provided with a collar that is more rigid than said vessel;
(b) extraction means for extracting liquid from said vessel and dispensing the liquid as a spray; and
(c) seal means arranged in sealing position between said extraction means and said vessel, said seal means being so arranged that:
(i) said collar of said vessel sealingly engages with said seal means,
(ii) said vessel is substantially sealed to said extraction means, and
(iii) the ingress of air into said vessel is substantially inhibited;
said seal means and extraction means being arranged such that said extraction means is operable to dispense liquid from said vessel whilst said seal means is in a sealing position.

25. A spray dispenser assembly according to claim 24, wherein said vessel is at least partially filled with a liquid suitable for use in a cleanroom environment.

26. A spray dispenser assembly according to claim 24, wherein said vessel is at least partially filled with a liquid chosen from one or more of a sterile liquid, a reactive liquid, a sterile alcohol and a biocide.

27. A spray dispenser assembly according to claim 24, in which said collar, having a circumference, has been formed separately from the neck portion and joined thereto around the collar circumference.

28. A spray dispenser assembly according to claim 24, in which said collar has been inserted into said neck portion and welded around the full collar circumference and wherein said welding of the collar has been performed a plurality of times by a welding apparatus, the orientation of said collar and neck portion in said welding apparatus being changed between each welding process so that a complete and secure circumferential weld is formed.

29. A spray dispenser assembly according to claim 24, in which said vessel comprises two sheets of plastics material welded together at their edges to form a substantially cylindrical vessel providing a neck end with an open neck portion disposed at one end thereof, with said collar disposed therein, and a closed end opposite the neck end.

30. A spray dispenser assembly according to any one of claim 29, in which excess material is removed from around said neck portion prior to welding the collar thereto.

31. A spray dispenser assembly according to claim 29, in which said closed end opposite said neck end is substantially curved.

32. A spray dispenser assembly according to claim 24, in which said vessel comprises plastics material which is inert, even upon irradiation or contact with biocides or other liquids that it may be used to contain.

33. A spray dispenser assembly according to claim 24, in which said collar and neck portion are made from the same material.

34. A spray dispenser assembly according to claim 24, in which said extraction means includes a dispensing line extending through said seal means and inside said vessel, said dispensing line being gripped in sealing engagement with a bore provided through said seal means.

35. A spray dispenser assembly according to claim 24, in which said vessel collapses from an expanded state to an increasingly collapsed state as liquid is extracted from said vessel.

36. A spray dispenser assembly according to claim 24 further comprising support means for supporting said vessel.

37. A spray dispenser assembly according to claim 36, in which said support means includes a support neck defining an opening for locating said extraction means, and said support neck being configured to cooperate in sealing engagement with said vessel.

38. A spray dispenser assembly according to claim 37, in which said collar has an annular lip which rests upon said support neck of said support means.

39. A spray dispenser assembly according to claim 36, in which said support means comprises a vent permitting air inside said support means, but externally of said vessel, to exist at ambient atmospheric pressure.

40. A spray dispenser assembly for the dispensing of liquids suitable for use in clean-room environments comprising
(a) a collapsible liquid impermeable vessel having an open end comprising a neck portion provided with a collar that is more rigid than said vessel;
(b) a trigger assembly comprising a dip tube extending inside said vessel;
(c) a bung provided with an aperature therethrough, said bung being arranged in sealing position between said trigger assembly and said vessel, said aperature being adapted to be in fluid communication with said dip tube, said bung being so arranged that:
(i) said collar of said vessel sealingly engages with said bung,
(ii) said vessel is substantially sealed to said trigger assembly, and
(iii) the ingress of air into said vessel is substantially inhibited;
said bung and trigger assembly being arranged such that said trigger assembly is operable to dispense liquid from said vessel whilst said bung is in a sealing position; and
(d) a support container provided with a support neck defining an opening for locating said trigger assembly, said support neck being configured to cooperate in sealing engagement with said vessel, wherein said collar has an annular lip which rests upon said support neck of said support container, said support container further comprising a vent permitting air inside said support container, but externally of said vessel, to exist at ambient atmospheric pressure.

41. A kit for forming a spray dispenser assembly, the kit comprising a collapsible liquid impermeable vessel for use in a spray dispenser assembly, extraction means for extracting liquid from said vessel and dispensing said liquid as a spray, a seal means able to sealing engage with said vessel and said extraction means, and support means for said vessel,
said vessel having an open and comprising a neck portion provided with a collar that is more rigid than said vessel;
said collar being adapted to sealingly engage with said seal means provided between said extraction means of said spray dispenser assembly and said vessel.
wherein said extraction means is in the form of a conventional pump dispenser trigger assembly, said sealing means is in the form of a bung adapted for sealing engagement with said vessel and having a bore therein adapted to sealingly engage with a dip tube of said trigger assembly, and said support means is in the form of a support container.

42. A method of manufacturing a collapsible liquid impermeable vessel for use in a spray dispenser assembly,
said vessel having an open end comprising a neck portion provided with a collar that is more rigid than said vessel;
said collar being adapted to sealingly engage with a seal means provided between an extraction means of said spray dispenser assembly and said vessel,
the method of manufacturing said vessel comprising a step of welding two sheets of plastic material together.

43. A method of manufacturing a collapsible liquid impermeable vessel according to claim 42, in which said collar is inserted into said neck portion and welded around the full collar circumference and wherein said welding of the collar is performed a plurality of times by a welding apparatus, the orientation of said collar and neck portion in said welding apparatus being changed between each welding process so that a complete and secure circumferential weld is formed.
